(19) United States
(12) Patent Application Publication
(10) Pub. No.: US 2010/0018362 A1
(43) Pub. Date: Jan. 28, 2010

(54) LOCKING PLIERS

(75) Inventors: Thomas M. Chervenak, Stanley, NC (US); David P. Engvall, Stanley, NC (US)

Correspondence Address: MOORE & VAN ALLEN PLLC, P.O. BOX 13706, Research Triangle Park, NC, 27709, US

(73) Assignee: IRWIN INDUSTRIAL TOOL COMPANY, Huntersville, NC (US)

(21) Appl. No.: 12/180,823

(22) Filed: Jul. 28, 2008

(51) Int. Cl. B25B 7/14; B25B 7/12

(52) U.S. Cl. 81/324; 81/342

(57) ABSTRACT

A lockable pliers comprises a fixed assembly comprising a first handle supporting a first jaw. A second jaw is movable relative to the first jaw between an open position and a closed, locked position. A second handle is movable relative to the first handle and is connected to the second jaw at a fixed pivot. A locking mechanism locks the jaws in the closed, locked position. A movable gripping member can move relative to the jaws when the jaws are in the closed, locked position and a torque is applied to the pliers.

This invention relates generally to locking pliers and, more particularly, to a locking pliers having an improved grip on the work piece.

### BACKGROUND

Pliers-type hand tools with toggle-locking mechanisms are generally known as locking pliers. These pliers usually comprise a fixed handle having a fixed jaw on one end thereof. A movable handle pivots a movable jaw relative to the fixed handle to open and close the jaws. To grip a workpiece the handles are tightly compressed such that the toggle mechanism locks the pliers onto the workpiece. Adjustments in the force applied by the jaws to the workpiece are generally made by turning an adjusting screw mounted in the fixed handle that engages the toggle locking mechanism. The adjusting screw is translated relative to the fixed handle to modify the physical dimensions of the toggle mechanism to vary the effective length of the toggle-locking mechanism. This adjustment varies the distance between the jaws and further adjustment of the screw varies the force applied by the jaws to the workpiece when the tool is locked. The pliers will remain firmly locked in place without the continuous application of force by the user.

### SUMMARY OF THE INVENTION

A locking pliers comprises a fixed assembly comprising a first handle supporting a first jaw. A second jaw is movable relative to the first jaw between an open position and a closed, locked position. A second handle is movable relative to the first handle and is connected to the second jaw at a fixed pivot. A toggle-link locking mechanism locks the second jaw in the closed, locked position. A movable gripping member on the second jaw can move relative to the jaw when the jaws are in the closed, locked position and a torque is applied to the pliers.

A method of gripping a workpiece with a locking pliers comprises providing a fixed assembly comprising a first handle supporting a first jaw. A second jaw movable relative to the first jaw between an open position and a closed, locked position is provided. A second handle movable relative to the first handle and connected to the second jaw at a fixed pivot is also provided. A toggle-link locking mechanism is provided for locking the second jaw in the closed, locked position. A movable gripping member is provided on the second jaw. A torque or turning force is applied to the pliers. The gripping member is allowed to move relative to the second jaw when the second jaws are in the closed, locked position and the torque or turning force is applied to the pliers.

### BRIEF DESCRIPTION OF THE DRAWINGS

FIG. 1 is a partially cut-away side view of one embodiment of a locking pliers according to the present invention.

FIGS. 2 and 3 are more detailed side view of one embodiment of the pliers of FIG. 1 where FIG. 3 shows the pliers with a turning force applied.

FIGS. 4 and 5 are more detailed side views of another embodiment of the pliers of FIG. 1 where FIG. 5 shows the pliers with a turning force applied.

FIGS. 6 and 7 are more detailed side views of another embodiment of the pliers of FIG. 1 where FIG. 7 shows the pliers with a turning force applied.

FIGS. 8 and 9 are more detailed side views of another embodiment of the pliers of FIG. 1 where FIG. 9 shows the pliers with a turning force applied.

FIGS. 10 and 11 are more detailed side views of another embodiment of the pliers of FIG. 1 where FIG. 11 shows the pliers with a turning force applied.

### DETAILED DESCRIPTION OF EMBODIMENTS OF THE INVENTION

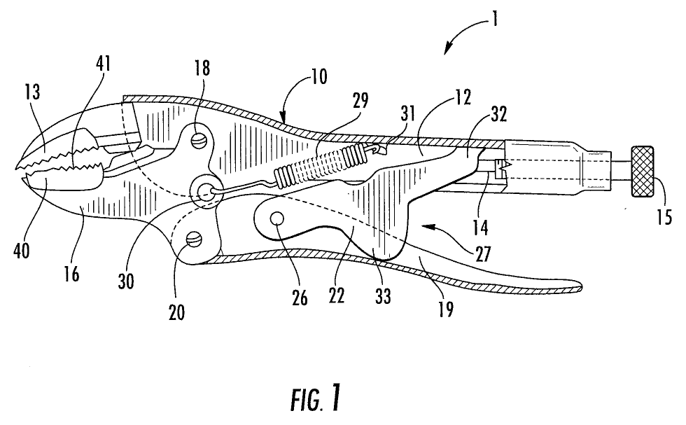

Referring to FIG. 1, pliers 1 include a fixed assembly 10 having a fixed handle 12 at one end and a fixed jaw 13 at the other end. A movable handle 19 is pivotably connected at one end to a movable jaw 16 by pivot pin 20. A pivot pin 18 connects the movable jaw 16 to the fixed assembly 10. The jaws may be shaped to function as any type of pliers where the locking action is useful.

A locking mechanism 27 locks the fixed jaw 13 relative to the movable jaw 16. A link 22 is pivotably connected to the movable handle 19 by a pivot pin 26. The opposite end 32 of link 22 is in sliding and pivoting contact with the end of adjustment screw 14. A projection 33 extends transversely to the length direction of the link 22 and acts as a stop when the jaws are in the closed position by making contact with the handle 19. A biasing spring 29 extends between an opening 30 on the movable jaw 16 to a tab 31 protruding from fixed handle 12. The spring 29 applies a bias which tends to rotate jaw 16 away from jaw 13.

When the jaws 13 and 16 are in the open position, the pivots points, 18, 20, 26 and the point of contact between the end 32 of link 22 with the end of the adjusting screw 14 are arranged as a polygon. When the jaws are in the closed position, the pivots 20, 26 and the point of contact between link 22 and screw 14 are substantially in a straight line with the pin 26 in an over-center position where it is positioned slightly inside (toward fixed assembly 10) of the line between pivot 20 and the point of contact between link 22 and the screw 14. The jaws 13 and 16 cannot be pried apart from the locked position by use of force which pulls or pushes on the jaws 13 and 16 because separation of the jaws is prevented by the over-center condition of the pin 26. However, the jaws 13 and 16 may be separated by applying a force to the movable handle 19 in a direction which moves the movable handle 19 away from the fixed handle 12. A configuration of the pivots which places the mechanism in a locked position when the jaws are closed or grasping a workpiece, can be considered an over-center mechanism when force applied directly to the jaws is not effective in separating the jaws. The jaws can only be opened by forces acting on the links of the mechanism. Other locking mechanisms are known and may also be used to lock the handles relative to one another. For example, the linkage may include a release lever to facilitate the unlocking of the links and/or the locking mechanism may include a compound linkage for effecting the locking function.

The end of the fixed handle 12, remote from the jaw 13, is completed with a threaded circular aperture through which threaded adjustment screw 14 is threadably engaged. The screw 14 terminates in an adjusting knob or head 15. The end 32 of the link 22 is slidably and pivotably engaged with the end of the adjusting screw 14. As is apparent from the drawing, turning the adjusting screw 14 changes the distance between the end 32 of the link 22 and the pivot point 18 of the movable jaw 16, whereby the jaws may be adjusted to grip objects of different dimensions with varying force.

Mounted on the movable jaw 16 is a movable gripping member 40 that provides the increased gripping force as will hereinafter be described. The gripping member 40 is opposed to the fixed jaw 13 and comprises the gripping surface 41 against which a work piece is gripped. The gripping member 40 is mounted to the movable jaw 16 such that it will move rearward and toward the fixed jaw 13 when the jaws are clamped on a work piece and a turning force is applied to the pliers as will hereinafter be described. As used herein, “front” or “frontward” means generally toward jaws 13 and 16 and “rear” or “rearward” means generally toward handles 12 and 19.

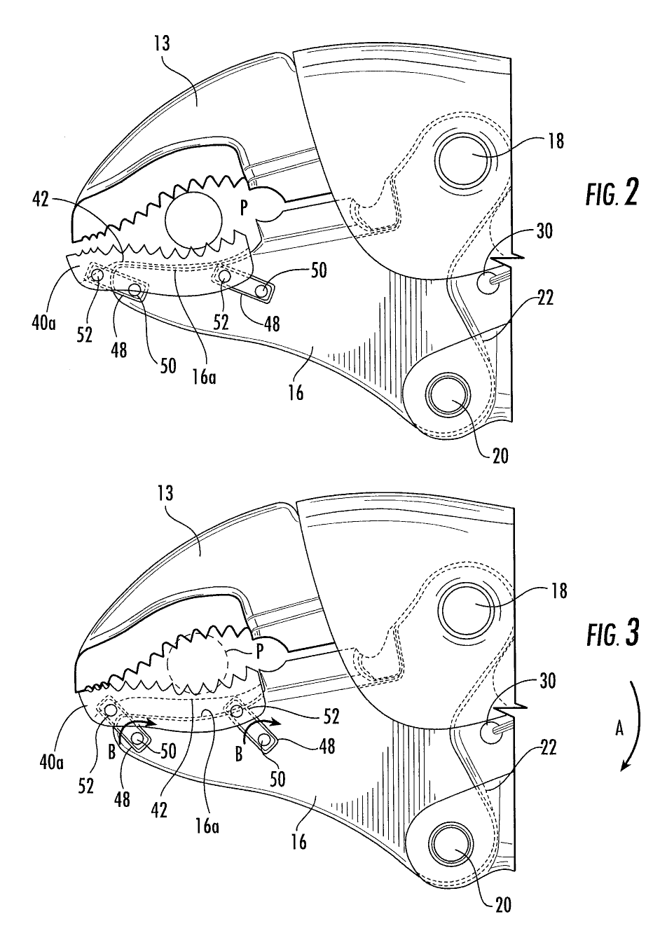

In the embodiment shown in FIGS. 2 and 3, the gripping member 40a has a groove 42 formed therein that receives the upper edge 16a of the movable jaw 16. In the rest position the interior surface of groove 42 may rest on upper edge 16a as shown in FIG. 2. The groove 42 and upper edge 16a may have complimentary shapes such that the gripping member 40a rests on the movable jaw 16 for substantially its entire length. The gripping member 40a is connected to the movable jaw 16 by pivoting links 48 where the links are connected to the movable jaw 16 at first pivot 50 and are connected to the gripping member 40a at a second pivot 52. In the illustrated embodiment two such links are shown one supporting the front end of the gripping member 40a and the other supporting the rear of the gripping member 40a. Further, it is to be understood that the opposite side of the gripping member 40a is supported in the same manner as the illustrated side such that the gripping member 40a is supported by four links 48. Other arrangements of the links may also be used.

The operation of the locking pliers will be explained with reference to FIGS. 2 and 3. In FIG. 2 the locking pliers are shown locked on a work piece P such as a pipe although the pliers will operate in a similar fashion for any shaped and sized work piece. In the locked position, the jaws tightly engage the work piece P and the toggle locking mechanism 27 is in the locked, over-center position where the pliers maintain the locked position without the application of force by the user. In existing locking pliers, when a turning force is applied to the pliers in the direction of arrow A, the jaws can lose purchase and “slip” over the work piece.

In operation of the pliers of the invention, the resultant force on the jaws when a turning force is applied in the direction of arrow A causes the links 48 that connect the gripping member 40a to the movable jaw 16 to rotate from the position shown in FIG. 2 to the position shown in FIG. 3 as represented by arrows B. As the links 48 rotate, the gripping member 40a moves rearward and toward the fixed jaw 13 such that the space between member 40a and jaw 13 decreases and the gripping force exerted on the work piece P is increased as the turning force applied to the pliers increases. This increased gripping force is shown in the drawings where the teeth of the jaws are shown penetrating the work piece P in FIG. 3. In actual use the jaw teeth may not actually penetrate the work piece, depending on the hardness of the work piece and the hardness of the teeth. As a result of the movement of the gripping member 40a, the pliers 1 resist slipping on the work piece at higher applied torques.

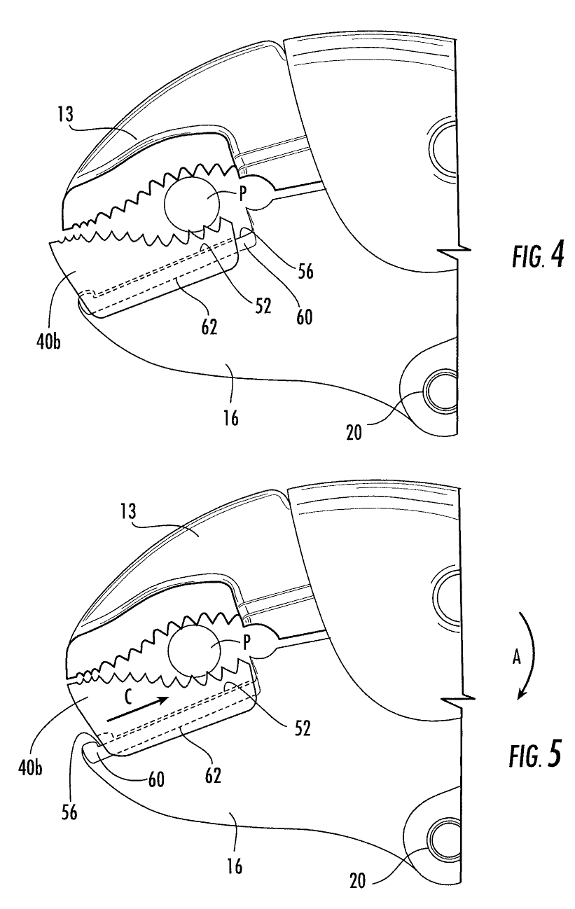

Alternate embodiments of the movable gripping member are shown in FIGS. 4 and 5 where the gripping member slides relative to the movable jaw rather than rotates as was explained with reference to FIGS. 2 and 3. In the embodiment of FIGS. 4 and 5, the gripping member 40b has a groove 52 formed therein that receives the upper edge 56 of the movable jaw 16. The interior surface of groove 52 rests on upper edge 56 and the sides 58 of the gripping member 40b extend over the movable jaw 16 to retain the gripping member 40b on the jaw 16. The jaw 16 may be provided with guides such as protrusions 60 that extend from both sides of jaw 16 along upper edge 56 and that engages slots 62 formed on the interior of groove 52 in the gripping member 40b to retain the gripping member 40b on the jaw 16. The groove 52 and upper edge 56 are substantially flat such that the gripping member can slide over the movable jaw in the direction of arrow C. Because surface 56 is angled toward the fixed jaw 13, the gripping member 40b will move rearward and towards the fixed jaw 13 as it slides on the movable jaw 16. As a result, as the gripping member 40b moves rearward, the distance between the jaws decreases. To increase the gripping effect of the pliers, the gripping member 40b and jaw 13 are configured such that the distance between the jaws narrows toward the front of the pliers. Such an arrangement can be used with any of the embodiments of the invention.

In operation of the pliers of the invention, the resultant force on the jaws when a turning force is applied in the direction of arrow A causes the gripping member 40b to slide on the movable jaw 16 from the position shown in FIG. 4 to the position shown in FIG. 5 toward the fixed jaw 13 and toward the rear of the pliers. As the gripping member 40b moves, the space between the jaw 13 and the gripping member 40b decreases such that the gripping force exerted on the work piece P is increased as the turning force applied to the pliers increases. As a result, the pliers 1 resist slipping on the work piece at higher applied torques.

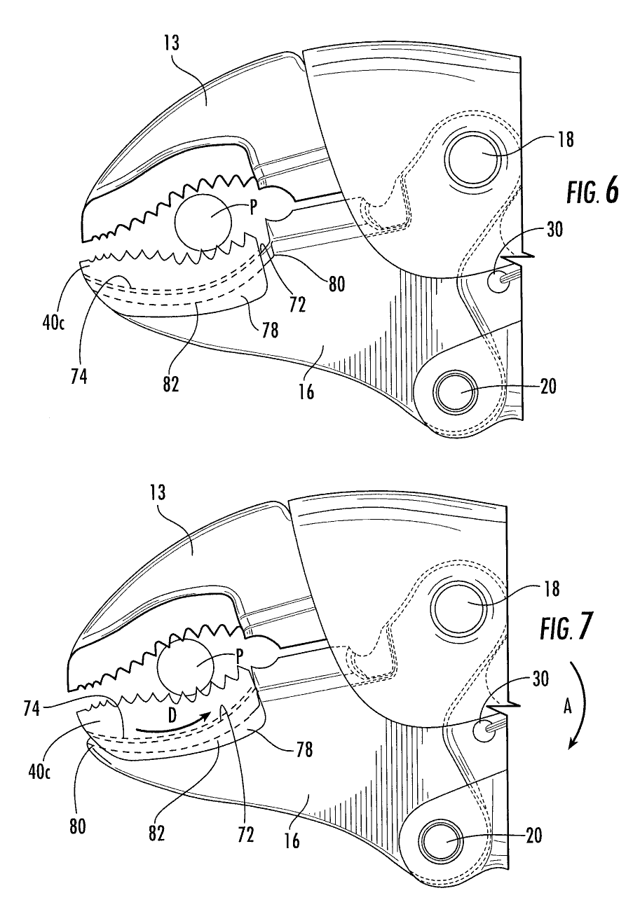

In the embodiment of FIGS. 6 and 7 the gripping member 40c has a groove 74 formed therein that receives the upper edge 72 of the movable jaw 16. The interior surface of groove 74 rests on upper edge 72 and the sides 78 of the gripping member 40c extend over the movable jaw 16 to retain the gripping member 40c on the jaw 16. The jaw 16 may be provided with guides such as protrusions 80 that extend from both sides of jaw 16 along upper edge 72 and that engage slots 82 formed in the gripping member 40c to retain the gripping member 40b on the jaw 16. The interior surface of groove 74 and upper edge 72 are curved such that the gripping member 40c can slide over the movable jaw 16 along an arcuate path as represented by arrow D. Because the jaw surface is arced toward the fixed jaw, the gripping member will move rearward and towards the fixed jaw as it slides on the movable jaw.

In operation of the pliers of the invention, the resultant force on the jaws when a turning force is applied in the direction of arrow A causes the gripping member 40c to slide on the movable jaw 16 from the position shown in FIG. 6 to the position shown in FIG. 7 toward the fixed jaw 13 and toward the rear of the pliers. As the gripping member moves the space between the fixed jaw 13 and the gripping member 40c narrows such that the gripping force exerted on the work piece P is increased as the turning force applied to the pliers increases. As a result, the pliers 1 resist slipping on the work piece at higher applied torques.

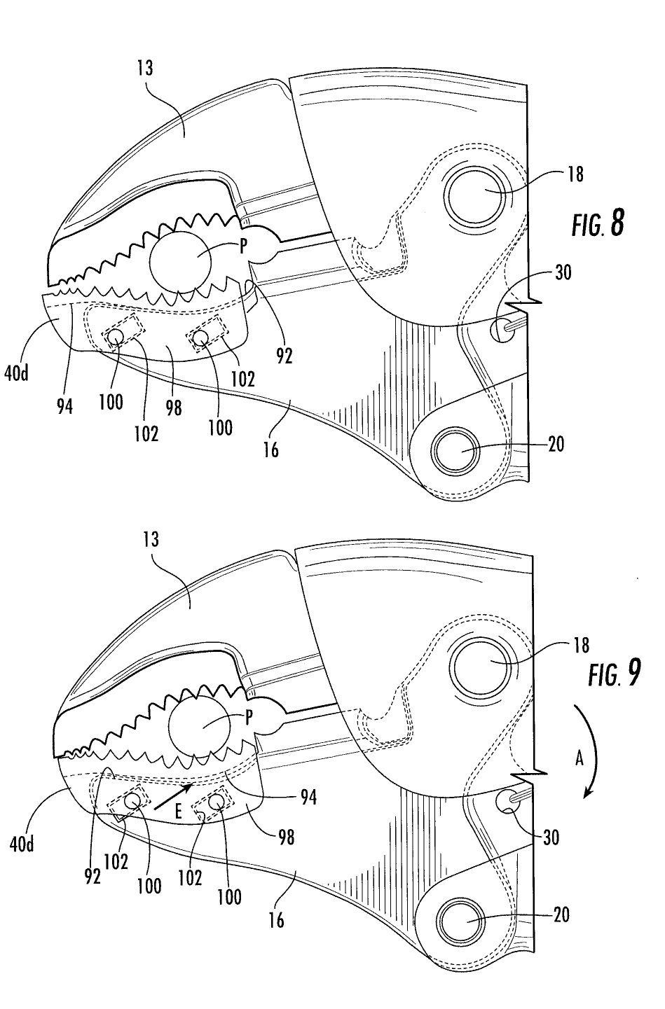

In the embodiment of FIGS. 8 and 9 the gripping member 40d has a groove 94 formed therein that receives the upper edge 92 of the movable jaw 16. The interior surface of groove 94 rests on upper edge 92 in the rest position shown in FIG. 8. The sides 98 of the gripping member 40d extend over the movable jaw to retain the gripping member on the jaw. The gripping member 40d is provided with protrusions such as pins 100 that engage guides such as slots 102 formed in the jaw 16 to retain the gripping member 40d on the jaw 16 and to guide the movement of the gripping member 40d relative to the jaws. Because the slots 102 are angled rearward and toward the fixed jaw 13, the gripping member 40d will move rearward and towards the fixed jaw 13 as it slides on the movable jaw 16.

In operation of the pliers of the invention, the resultant force on the jaws when a turning force is applied in the direction of arrow A causes the gripping member 40d to slide in the slots 102 formed on the movable jaw 16 from the position shown in FIG. 8 to the position shown in FIG. 9 toward the fixed jaw 13 and toward the rear of the pliers in the direction of arrow E. As the gripping member 40d moves, the space between the jaw 13 and the gripping member 40d decreases such that the gripping force exerted on the work piece P is increased as the turning force applied to the pliers increases. As a result, the pliers 1 resist slipping on the work piece at higher applied torques.

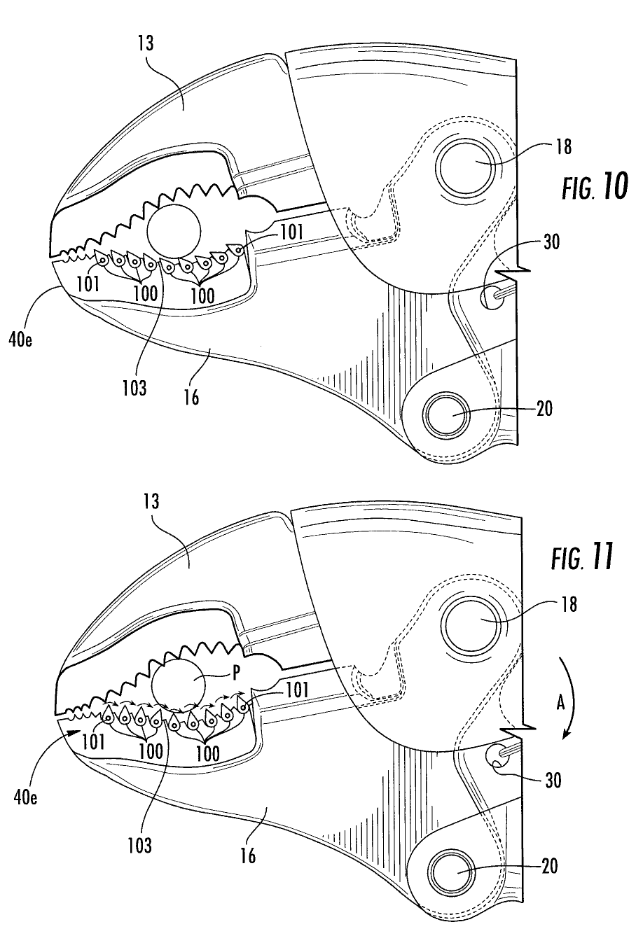

In the embodiment shown in FIGS. 10 and 11, the gripping member 40e comprises a plurality of individual teeth 100 each pivotably mounted to the jaw 16 such that they extend beyond the edge surface 103 of jaw 16 and form the gripping surface that contacts the work piece P.

In operation of the pliers of the invention, the resultant force on the jaws when a turning force is applied in the direction of arrow A causes the teeth 100 to rotate toward jaw 13 from the retracted position shown in FIG. 10 to the extended position shown in FIG. 11 as represented by the arrows in FIG. 11. As the teeth 100 rotate, the space between the jaw 13 and the distal edges of the teeth 100 decreases such that the gripping force exerted on the work piece P is increased as the turning force applied to the pliers increases. As a result, the pliers 1 resist slipping on the work piece at higher applied torques.

While the movable gripping members are shown on the movable jaws in the illustrated embodiments, the movable gripping members may be provided on the fixed jaws rather than on the movable jaws. Moreover, the movable gripping members may be provided on both the fixed jaw and the movable jaw.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A lockable pliers comprising:
a fixed assembly comprising a first handle supporting a first jaw;
a second jaw movable relative to the first jaw between an open position and a closed, locked position;
a second handle movable relative to the first handle, said second handle connected to the second jaw;
a toggle-link locking mechanism for locking the first and second jaws in the closed, locked position;
a gripping member movably mounted on the second jaw such that the gripping member can move closer to the first jaw when the second jaw is in the closed, locked position and a torque is applied to the pliers.

2. The locking pliers of claim 1 wherein said gripping member slides along said second jaw.

3. The locking pliers of claim 2 wherein said gripping member slides along a straight path.

4. The locking pliers of claim 2 wherein said gripping member slides along an arcuate path.

5. The locking pliers of claim 1 wherein the gripping member moves toward the rear of the pliers when a torque is applied to the pliers.

6. The locking pliers of claim 1 wherein when the gripping member moves the gripping member is moved toward the first jaw.

7. The locking pliers of claim 1 wherein the gripping member moves away from the second jaw.

8. The locking pliers of claim 7 wherein the gripping member is supported in guides on the second jaw such that said gripping member moves in said guides.

9. The locking pliers of claim 8 wherein the guides extend toward said first jaw.

10. The locking pliers of claim 1 wherein said gripping member rotates relative to said second jaw.

11. The locking pliers of claim 1 wherein the gripping member is connected to the second jaw by a link.

12. The locking pliers of claim 11 wherein the link is connected to the second jaw at a first pivot and to the gripping member at a second pivot.

13. The locking pliers of claim 1 wherein said gripping member comprises a plurality of teeth each of said teeth being rotatable relative to said second jaw.

14. The locking pliers of claim 1 each of said plurality of teeth is connected to said second jaw at a pivot.

15. A method of gripping a workpiece with a locking pliers comprising:
providing a fixed assembly comprising a first handle supporting a first jaw;
providing a second jaw movable relative to the first jaw between an open position and a closed, locked position;
providing a second handle movable relative to the first handle, said second handle connected to the second jaw;
providing a toggle-link locking mechanism for locking the second jaw in the closed, locked position;
providing a gripping member movably mounted on said second jaw;
applying a torque to the pliers; and
allowing the gripping member to move relative to the fixed assembly when the second jaw is in the closed, locked position the torque is applied to the pliers.

16. The method of claim 15 wherein said gripping member slides along said second jaw.

17. The method of claim 15 wherein the gripping member moves away from the second jaw.

18. The method of claim 15 wherein the gripping member is supported in guides on the second jaw such that said gripping member moves in said guides.

19. The method of claim 15 wherein said gripping member rotates relative to said second jaw.

20. The method of claim 15 wherein the gripping member is connected to the second jaw by a link.

21. The method of claim 15 wherein said gripping member comprises a plurality of teeth each of said teeth being rotatable relative to said second jaw.

22. A lockable pliers comprising:
a fixed assembly comprising a first handle supporting a first jaw;
a second jaw movable relative to the first jaw between an open position and a closed, locked position;
a second handle movable relative to the first handle, said second handle connected to the second jaw at a fixed pivot;
a toggle-link locking mechanism for locking the second jaw in the closed, locked position;
a gripping member movably mounted on one of the first jaw and the second jaw such that the gripping member can move when the second jaw is in the closed, locked position and a torque is applied to the pliers.

23. A lockable pliers comprising:
a first handle connected to a first jaw;
a second jaw connected to a second handle such that said first jaw and said second jaw are movable relative to one another between an open position and a closed, locked position;
a toggle-link locking mechanism for locking the first jaw and second jaw in the closed, locked position;
a gripping member movably mounted on the first jaw such that the gripping member can move closer to the second jaw when the first and second jaws are in the closed, locked position and a torque is applied to the pliers.
